(19) United States
(12) Patent Application Publication
(10) Pub. No.: US 2011/0127302 A1
(43) Pub. Date: Jun. 2, 2011

(54) Closing Plate and Sliding Closure on the Spout of a Receptacle for Molten Metal

(75) Inventors: Benno Steiner, Nebikon (CH); Werner Keller, Steinhausen (CH); Urs Truttmann, Baar (CH)

(73) Assignee: STOPINC AKTIENGESELLSCHAFT, HUNENBERG (CH)

(21) Appl. No.: 12/988,065

(22) PCT Filed: Apr. 17, 2009
(86) PCT No.: PCT/EP2009/002815

§ 371 Date: Feb. 11, 2011

(30) Foreign Application Priority Data
Apr. 17, 2008 (CH) 603/08

(51) Int. Cl. B67D 3/00

(52) U.S. Cl. 222/559

(57) ABSTRACT

A closing plate for a sliding closure on the spout of a receptacle for molten metal, especially of a converter, comprises an elongate refractory plate (11) and a sheet metal jacket (12) surrounding the same. The refractory plate (11) has a sliding surface (14, 16) which can be braced with a sliding surface of a refractory closure plate interacting therewith or with a sliding surface (21′) of a refractory head part (21). The refractory plate (11) has a tapering section (26, 28, 29) which forms an angle (a) with the sliding surface (14, 15) on at least one side delimiting the sliding surface (14, 15), said tapering section being associated with a section of the refractory plate (11) that projects beyond the sheet metal jacket (12). The closing plate according to the invention allows the risk of damage to the front faces of the refractory parts to be braced with each other to be substantially reduced during bracing of the parts with each other and/or during a relative adjustment of the refractory parts that are braced with each other.

The invention relates to a closing plate for a sliding closure on the spout of a receptacle for molten metal, especially of a converter, according to the preamble to claim 1 and a sliding closure according to claim 5.

Sliding closures on the spout of receptacles for molten metal are known in a wide variety of embodiments. A sliding closure, which is used in particular to open and close a converter spout opening, is disclosed for example in EP 0 819 488 B1. It comprises a housing frame in which are disposed a stationary refractory closing plate (a so-called base plate) and a refractory sliding plate held in a sliding unit displaceable in relation to said closing plate. The sliding plate can be pressed sealingly with its upper sliding surface against a lower sliding surface of the base plate. The housing frame is fastened releaseably to a base plate fixed to the receptacle, the base plate being braceable with its upper sliding surface with a refractory spout head part inserted into the base plate. During casting operation the refractory parts are subjected to a high degree of wear. It is therefore necessary to change them relatively frequently. For this purpose the housing frame must be respectively released from the base plate.

Since, as shown from experience, when using the sliding closure on the converter spout the base plate in particular wears very quickly, it is known from an earlier Swiss patent application No. 00603/08 to dispose moveably in the housing frame a case with at least two base plates in the housing frame, by means of the displacement a worn base plate being able to be removed from the operating position, and replaced by another base plate without the housing frame having to be removed from the base plate. In this way it is possible to maintain the casting operation for longer until the other refractory parts are also due to be changed.

The closing plates for a sliding closure are known to comprise a respective elongate refractory plate surrounded by a sheet metal jacket and which can also be in several parts.

The object forming the basis of the present invention is to provide a closing plate for a sliding closure on the spout of a receptacle for molten metal, in particular of a converter, which enables particularly gentle bracing with another closing plate or with a refractory spout head part. Furthermore, a sliding closure particularly suitable for converters is to be further improved.

This object is achieved according to the invention by a closing plate having the features of claim 1 and by a sliding closure having the features of claim 5.

Further preferred embodiments of the closing plate according to the invention form the subject matter of the dependent claims.

With the closing plate according to the invention the risk of damage to the front faces of the refractory parts to be braced with each other when starting the bracing and/or during a relative displacement of the refractory parts to be braced with each other can be substantially reduced.

In the following the invention is described in greater detail by means of the drawings. These show as follows:

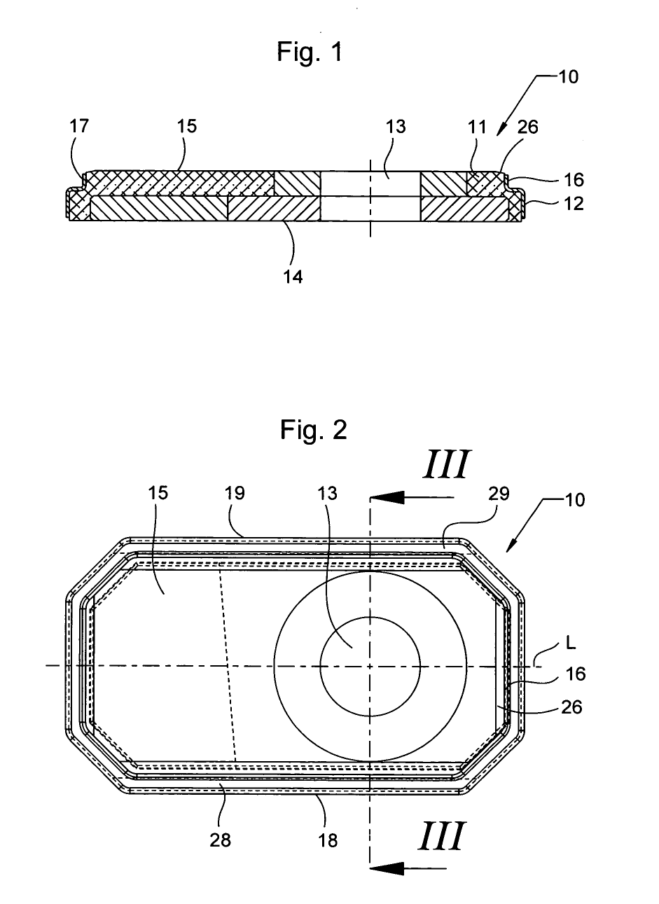

FIG. 1 is a longitudinal section of an exemplary embodiment of a closing plate according to the invention;

FIG. 2 is a top view of the closing plate according to FIG. 1;

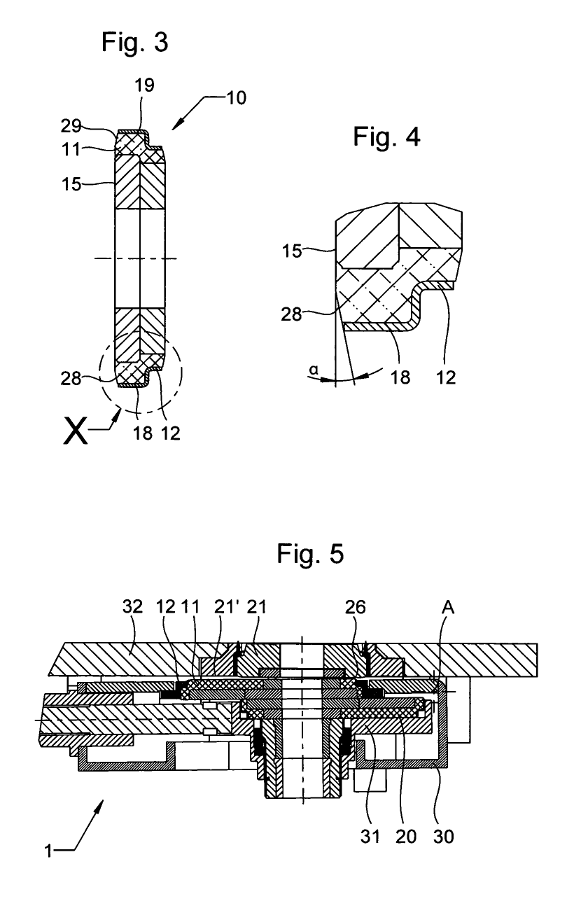

FIG. 3 is a section along line III-III in FIG. 2;

FIG. 4 is a detail X from FIG. 3 in an enlarged scale;

FIG. 5 is a longitudinal section of an exemplary embodiment of a sliding closure upon pivoting onto the spout of a converter;

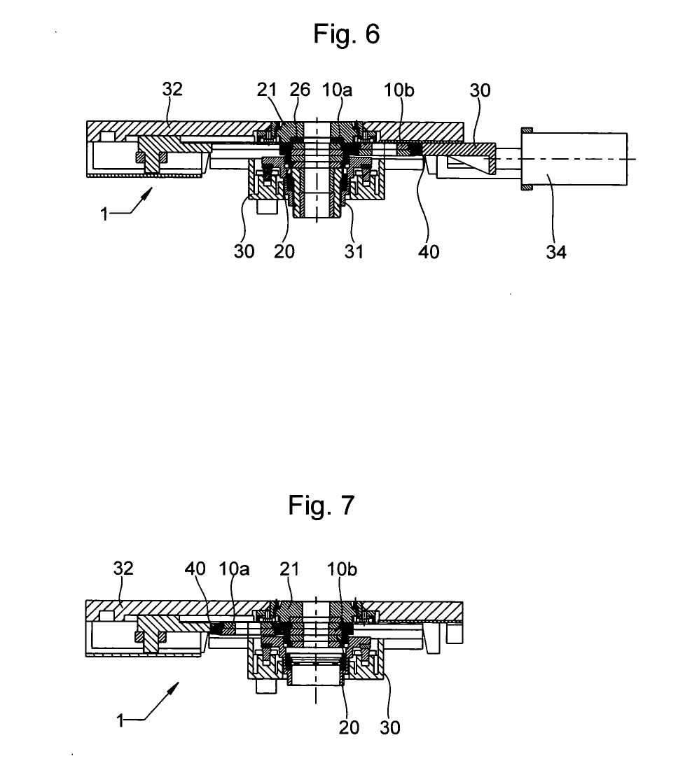

FIG. 6 is a cross-section of the sliding closure according to FIG. 5 with a case located in an initial position and containing two base plates; and

FIG. 7 is a cross-section of the sliding closure according to FIG. 5 with the case in a final position.

In FIG. 1 to FIG. 4 a closing plate 10 for a sliding closure on the spout of a receptacle for molten metal is shown. This can be, for example, a so-called base plate of a sliding closure 1 for a converter, shown in greater detail in FIGS. 5 to 7, as will be described in greater detail below. The closing plate 10 has an elongate form, and optionally an octagonal outer contour. It comprises a multi-part refractory plate 11 and a sheet metal jacket 12 surrounding the latter. The refractory plate 11 provided with a spout opening 13 has a lower sliding surface 14 and an upper sliding surface 15. The refractory plate 11 can on the one hand be braced with the lower sliding surface 14 with a sliding plate 20 of the sliding closure 1, and on the other hand with the upper sliding surface 15 with a lower sliding surface 21′ of a refractory receptacle spout head part 21.

According to the invention the refractory plate 11 has in a section projecting beyond the sheet metal jacket 12 a tapering section 26 which forms an angle α with the sliding surface 15 at least along a side delimiting the sliding surface 15 along one of the two narrow sides 16, 17, the angle α preferably being between 10° and 15°. In addition, with the refractory plate 11 as well as the tapering section 26 a respective tapering section 29, 29 is provided with the sliding surface 14, these being associated with the two longitudinal sides 18, 19 parallel to the longitudinal axis L.

As already mentioned, the closing plate 10 according to the invention can be accommodated as a stationary base plate in a housing frame 30 of the sliding closure 1 according to FIG. 5 in which housing frame 30 is displaceably disposed a sliding unit 31 with the sliding plate 20, the longitudinal axis L of the closing plate 10 extending in the direction of displacement of the sliding closure 1. The housing frame 30 is removeably attached to a base plate 32 fixed to the receptacle. Preferably suspension means are provided for the pivotable positioning of the housing frame 30 on the base plate 32 fixed to the receptacle, the pivot axis A extending at a right angle to the direction of displacement of the sliding unit 31.

In FIG. 5 it is particularly illustrated how the housing frame 30 with the refractory parts mounted therein are pivoted about the axis A and are then fixed to the base plate 32 using fixing means (not shown), the refractory parts being braced with spring elements provided in the housing frame 30.

With the tapering section 26 according to the invention of the narrow side 16 of the refractory plate 11 lying closer to the pivot axis A, with contact of the base plate with the lower sliding surface 21′ of the refractory spout head part 21 fitted in the base plate 32 fixed to the receptacle damage to these refractory parts normally made of ceramic material is largely avoided. As additional security the spring elements are designed with a spring characteristic curve such that initially only very slight contact forces come into contact with this tapered section 26 of the refractory plate 11 striking the head part first before the full spring force takes effect upon the plate 11 resting two-dimensionally on the head part 21.

With the sliding closure 1 according to FIG. 6 and FIG. 7 the housing frame 30 contains a case 40 displaceable at a right angle to the direction of displacement of the sliding unit 20 with at least two closing plates 10a, 10b serving as base plates, it being possible to remove the one closing plate 10a by displacing the case 40 from the operating position according to FIG. 6, and replacing it with the other closing plate 10b (FIG. 7), without the housing frame 30 having to be dismantled. The precise design and mode of operation of this type of sliding closure can be learnt from the previously mentioned earlier Swiss patent application No. 00603/08, and is therefore not described in detail.

According to the invention the refractory plates 11 of all closing plates 10a, 10b are provided with tapering sections 28, 29, at least along the longitudinal sides 18, 19 to the front in relation to the case displacement so as to avoid damage with their sliding surfaces during the mutual displacement of the refractory parts braced with one another with full contact force. This risk of striking of the edges arises primarily due to the differences in thickness of the refractory plates and the head part 21 arising due to dimensional tolerances. Preferably, both longitudinal sides 18, 19 of the respective refractory plate 11 are provided with tapering sections 28, 29, in particular if a to and fro displacement of the case 40 is provided for the purpose of simplifying the changeover process.

The closing plate 10 serving as a stationary base plate could by all means also have tapering sections on the sliding surface 14 associated with the sliding plate 20 on the narrow sides 16, 17, or the sliding plate 20 could itself be provided with this type of tapering sections.

This type of sliding plate could also be formed on the side facing away from the sliding surface with a spring known in its own right and so only be provided on the one side with a sliding surface with which within the framework of the invention, for example, on the one narrow side of the sliding surface a tapering section could be provided so that upon pivoting the sliding unit by means of two-dimensional contact, due to this tapering section the sliding plate would not come into contact square on with the base plate.

The invention is illustrated sufficiently by the exemplary embodiments described. It could, however, also be implemented by additional versions. Therefore, the sheet metal jacket 12 surrounding the refractory plate 11 can be a deep-drawn sheet metal, a binding or also a cassette frame or similar.

With a platform with which the outer sides extend at an angle to the longitudinal axis L of the plate or these outer sides are rounded, this tapering section according to the invention with the refractory plate could not be provided over the whole length, but only in a partial section.

1. A closing plate for a sliding closure on the spout of a receptacle for molten metal, especially of a converter, comprising an elongate refractory plate (11) and a sheet metal jacket (12) surrounding the latter, the refractory plate (11) being braceable with a sliding surface (14, 15) with this type or some other refractory closing plate or with a sliding surface (21′) of a refractory head part (21), characterised in that the refractory plate (11) has a tapering section (26, 28, 29) which forms an angle (α) with the sliding surface (14, 15) at least along one side (16, 17, 18, 19) delimiting the sliding surface (14, 15), said tapering surface being associated with a section of the refractory plate (11) that projects beyond the sheet metal jacket (12).

2. The closing plate according to claim 1, characterised in that the angle (α) of this tapering section (26, 28, 29) is between 10° and 15°.

3. The closing plate according to claim 1, characterised in that the tapering section (26) is associated with a narrow side (16) of the refractory plate (11) directed at a right angle to the plate's longitudinal axis (L).

4. The closing plate according to claim 1, characterised in that the tapering section (28, 29) is associated with at least one, preferably both longitudinal sides (18, 19) of the refractory plate (11) extending parallel to the plate's longitudinal axis (L).

5. A sliding closure on the spout of a receptacle for molten metal, in particular of a converter, comprising a closing plate (10) according to claim 1, characterised in that the closing plate (10) is accommodated as a stationary base plate in a housing frame (30) that can be attached to a base plate (32) fixed to the receptacle and in which can be disposed displaceably a sliding unit (31) provided with a sliding plate (20), the plate's longitudinal axis (L) extending in the direction of displacement of the sliding unit (31), the closing plate (10) and its refractory plate (11) provided with the tapering section (26, 28, 29) being braceable with its sliding surface (15) with a sliding surface (21′) of a refractory spout head part (21) inserted into the base plate (32).

6. The sliding closure according to claim 5, characterised in that suspension means are provided for the pivotable positioning of the housing frame (30) on the base plate (32) fixed to the receptacle and fixing means for the releaseable fastening of the latter, the pivot axis (A) extending at a right angle to the direction of displacement of the sliding unit (31), the narrow side (16) of the refractory plate (11) lying closer to the pivot axis (A) being provided with the tapering section (26).

7. The sliding closure according to claim 5, characterised in that there is displaceably disposed in the housing frame (30) a case (40) which contains in addition to the one closing plate (10a) at least one further, identically formed closing plate (10b), it being possible to bring the further closing plate (10b) into an operating position by displacing the case (40) and so it being possible to replace the one case (10a).

8. The sliding closure according to claim 7, characterised in that the direction of displacement of the cassette (40) extends at a right angle to the direction of displacement of the sliding unit (31).

9. The sliding closure according to claim 8, characterised in that the refractory plates (11) of all of the closing plates (10a, 10b) have tapering sections (28, 29), at least along the longitudinal sides (18, 19) to the front in relation to the case displacement.

10. The sliding closure according to claim 7, characterised in that the case (40) can be displaced to and fro between its initial position and its final position, both longitudinal sides (18, 19) of the respective refractory plate (11) having tapering sections (28, 29).

11. The closing plate according to claim 2, characterised in that the tapering section (26) is associated with a narrow side (16) of the refractory plate (11) directed at a right angle to the plate's longitudinal axis (L).

12. The sliding closure according to claim 6, characterised in that there is displaceably disposed in the housing frame (30) a case (40) which contains in addition to the one closing plate (10a) at least one further, identically formed closing plate (10b), it being possible to bring the further closing plate (10b) into an operating position by displacing the case (40) and so it being possible to replace the one case (10a).
